(19) United States
(12) Patent Application Publication
(10) Pub. No.: US 2016/0109323 A1
(43) Pub. Date: Apr. 21, 2016

(54) METHOD FOR ANALYZING MEASURED SIGNAL IN RESONANCE FATIGUE TEST AND APPARATUS USING THE SAME

(71) Applicant: KOREA INSTITUTE OF MACHINERY & MATERIALS, Daejeon (KR)

(72) Inventors: Hakgu LEE, Changwon-si (KR); Jinbum MOON, Changwon-si (KR); Jinbong KIM, Gimhae-si (KR); Jihoon KIM, Changwon-si (KR); Wookyoung LEE, Gimhae-si (KR); Hongkyu JANG, Busan (KR)

(21) Appl. No.: 14/885,694

(22) Filed: Oct. 16, 2015

Related U.S. Application Data
(60) Provisional application No. 62/065,435, filed on Oct. 17, 2014.

(51) Int. Cl. G01M 5/00

(52) U.S. Cl. CPC G01M 5/0016; G01M 5/0008; G01M 5/0025

(57) ABSTRACT

A method and apparatus for analyzing a measured signal are provided in a resonance fatigue test that causes a complicated behavior and nonsymmetrical bending of a test article such as a wind turbine blade due to a coupling effect. In the method, a processor of the apparatus receives the measured signal from each of at least two measurement sensors attached to the test article and then extracts a moment load from the received measured signal by considering all of a first measured value in a first direction due to a first direction load, a second measured value in a second direction due to the first direction load, a third measured value in the first direction due to a second direction load, and a fourth measured value in the second direction due to the second direction load.

### CROSS REFERENCE TO RELATED APPLICATIONS

The present application claims the benefit of US provisional patent application No. 62/065,435 filed Oct. 17, 2014. The present application is also related to copending patent application Ser. No. 14/885,644 titled “Method and Apparatus of Moment Calibration for Resonance Fatigue Test” and copending patent application Ser. No. 14/885,731 titled “Method and Apparatus of Multi-axis Resonance Fatigue Test” both filed on Oct. 16, 2015. The disclosures of the above-listed applications are hereby incorporated by reference herein in their entirety.

### TECHNICAL FIELD

The present invention relates to a fatigue test for a test article such as a wind turbine blade.

### BACKGROUND

A wind turbine blade is a distinguishing component of a wind power generator, and it would not be wrong to say the performance and lifetime of the entire system depend on the performance of a blade. A recent several-MW blade which is about several tens of meters long and weighs more than ten tons should be designed considering various load conditions and verified through a test. There are a static test and a fatigue test as tests for reliability verification of a blade.

Normally a fatigue test for a wind turbine blade is performed using a fatigue test apparatus 100 as shown in FIG. 1. Referring to FIG. 1, a blade 110 is fixed at a root to a test stand 120, thus forming a cantilever beam. An exciter 130 is mounted on the blade 110 and applies a repeated force to the blade 110 so as to induce oscillation of a cantilever beam.

An excitation force is adjusted so that a bending moment distribution caused by oscillation of the blade 110 can exceed a target bending moment distribution. Using resonance, the blade 110 vibrates at a certain amplitude in a target cycle. Typically such a target cycle is set to several million cycles. For example, a full-scale fatigue test needs a flapwise test with 1 million cycles and an edgewise test with 2 million cycles, spending a very long test time of about three months.

Fatigue testing methods are classified into two categories, i.e., forced-displacement type fatigue testing and resonance type fatigue testing. Between both, the latter type has recently attracted attention in view of providing a greater oscillating range required. Namely, a resonance fatigue test can be efficiently conducted at the natural frequency exploiting resonance. Since allowing the blade to oscillate at a great amplitude even by a smaller actuating force, a resonance fatigue test can considerably reduce energy required for a fatigue test.

Additionally, a fatigue test includes a flapwise test for actuating the blade in a flapwise direction and an edgewise test for actuating the blade in an edgewise direction. A single-axis test is to perform separately both tests, and a dual-axis test is to perform simultaneously both tests.

Further, dual-axis resonance fatigue tests are divided into one case having same frequencies and constant amplitude in flapwise and edgewise directions, and the other case having different frequencies and variable amplitude in flapwise and edgewise directions.

FIG. 2A is a diagram illustrating the displacement of blade tip in the former case, and FIG. 2B is a graph illustrating the blade displacement in an edgewise direction in the former case. In FIG. 2A, the horizontal axis represents the blade tip displacement (unit: inch) in an edgewise direction (also referred to as lead-lag tip displacement), and the vertical axis represents the blade tip displacement (unit: inch) in a flapwise direction (also referred to as flap tip displacement). In FIG. 2B, the horizontal axis represents time (unit: second), and the vertical axis represents edgewise blade displacement (unit: meter). Additionally, FIG. 3A is a diagram illustrating the displacement of blade tip in the latter case, and FIG. 3B is a graph illustrating the blade displacement in an edgewise direction in the latter case. Further, FIG. 3C is a diagram illustrating the contour of blade motions superposed at some positions on blade in the latter case. In FIG. 3B, the horizontal axis represents time (unit: second), and the vertical axis represents edgewise blade displacement (unit: meter). In FIG. 3C, 55.6 m, 48.0 m, etc. respectively represent distances from a blade root.

In the former case, flapwise and edgewise blade motions give rise to no interference therebetween. Further, such motions are made with a single frequency. It is therefore possible and not difficult to predict the behavior of blade and also perform a test setup through a harmonic analysis.

By the way, the latter case is more realistic than the former case. In the latter case, flapwise and edgewise blade motions with different frequencies give rise to interference therebetween. Therefore, a harmonic analysis is not possible. Even in a transient analysis, due to two frequencies with no multiple relations as shown in FIG. 3B, finding convergence is very difficult and requires a great burden of calculation. As a result, the latter case makes it difficult to predict the behavior of blade and also perform a test setup.

A real resonance fatigue test is in a dynamic load state and thereby causes nonsymmetrical bending of the blade due to stiffness coupling even in a single-axis test as well as in a dual-axis test. Therefore, as shown in FIGS. 3A and 3C, the blade moves in a diagonal direction which is not parallel with the direction of excitation force applied to the blade. This diagonal motion of the blade brings about an inertia force having horizontal and vertical components, resulting in dual-axis load components. Namely, interference between flapwise and edgewise motions of the blade inherently causes an inertia coupling (or referred to as a mass coupling).

For the above reasons, a signal measured from the blade during a resonance fatigue test subjected to interference between flapwise and edgewise motions is very complicated and makes it difficult to extract a desired physical quantity. Therefore, for exactly predicting the behavior of blade and efficiently performing a test setup in a resonance fatigue test, technique to analyze a signal measured from the blade is required in the art.

### SUMMARY

Accordingly, in order to address the aforesaid or any other issue, the present invention provides new technique capable of effectively extracting a desired physical quantity from a measured signal in a resonance fatigue test that causes a complicated behavior and nonsymmetrical bending of a test article due to a coupling effect.

The present invention provides a method for analyzing a measured signal in a resonance fatigue test of a test article. This method may include steps of: receiving the measured signal from each of at least two measurement sensors attached to the test article; and extracting a moment load from the received measured signal by considering all of a first measured value in a first direction due to a first direction load, a second measured value in a second direction due to the first direction load, a third measured value in the first direction due to a second direction load, and a fourth measured value in the second direction due to the second direction load.

Various embodiments of the present invention provide a method for analyzing a measured signal in a resonance fatigue test of a test article, the method including steps of: receiving the measured signal from each of at least two strain gauges attached to the test article; and extracting a moment load from the received measured signal by considering all of a first flapwise strain due to a flapwise load, a first edgewise strain due to the flapwise load, a second flapwise strain due to an edgewise load, and a second edgewise strain due to the edgewise load.

In the method, the at least two strain gauges may be disposed at different positions on the same cross-section of the test article.

The method may further include comparing the extracted moment load with a target moment load in case of a single-axis resonance fatigue test.

Additionally, the method may further include comparing the extracted moment load with a target moment load after converting the extracted moment load into single-axis equivalent moment loads in case of a dual-axis resonance fatigue test. In this case, the dual-axis resonance fatigue test may be performed with different frequencies in flapwise and edgewise directions.

Meanwhile, various embodiments of the present invention provide a resonance fatigue test apparatus for a test article. This apparatus may include a test stand configured to fix one end of the test article; an exciter mounted on the test article and configured to apply a repeated force to the test article so as to induce oscillation; a controller connected to the exciter and configured to apply a driving force to the exciter; at least two measurement sensors attached to the test article and configured to measure a physical quantity caused by the oscillation of the test article and thereby to create a measured signal; and a processor configured to receive the measured signal from each of the at least two measurement sensors, and to extract a moment load from the received measured signal by considering all of a first measured value in a first direction due to a first direction load, a second measured value in a second direction due to the first direction load, a third measured value in the first direction due to a second direction load, and a fourth measured value in the second direction due to the second direction load.

In the apparatus, the measurement sensor may be a strain gauge, the first direction and the second direction may be a flapwise direction and an edgewise direction, respectively, and the measured value may be strain.

In the apparatus, the at least two measurement sensors may be disposed at different positions on the same cross-section of the test article.

The apparatus may further include a memory configured to store test conditions and data required for or associated with a resonance fatigue test, including a target moment load and the moment load extracted by the processor.

In the apparatus, the processor may be further configured to compare the extracted moment load with the stored target moment load in case of a single-axis resonance fatigue test.

Additionally, in the apparatus, the processor may be further configured to compare the extracted moment load with the stored target moment load after converting the extracted moment load into single-axis equivalent moment loads in case of a dual-axis resonance fatigue test. In this case, the dual-axis resonance fatigue test may be performed with different frequencies in flapwise and edgewise directions.

In the above method and apparatus, the test article may be one of a wind turbine blade, a bridge, a building, a yacht mast, or any other structure which has a possibility of oscillation and needs a fatigue test.

### BRIEF DESCRIPTION OF THE DRAWINGS

FIG. 1 is a schematic diagram illustrating a typical resonance fatigue test apparatus.

FIG. 2A is a diagram illustrating the displacement of blade tip in case of a dual-axis resonance fatigue test having same frequencies and constant amplitude in flapwise and edgewise directions.

FIG. 2B is a graph illustrating the blade displacement in an edgewise direction in case of a dual-axis resonance fatigue test having same frequencies and constant amplitude in flapwise and edgewise directions.

FIG. 3A is a diagram illustrating the displacement of blade tip in case of a dual-axis resonance fatigue test having different frequencies and variable amplitude in flapwise and edgewise directions.

FIG. 3B is a graph illustrating the blade displacement in an edgewise direction in case of a dual-axis resonance fatigue test having different frequencies and variable amplitude in flapwise and edgewise directions.

FIG. 3C is a diagram illustrating the contour of blade motions superposed at some positions on blade in case of a dual-axis resonance fatigue test having different frequencies and variable amplitude in flapwise and edgewise directions.

FIG. 4 is a schematic diagram illustrating a resonance fatigue test apparatus according to an embodiment of the present invention.

FIG. 5 is a flow diagram illustrating a method for analyzing a measured signal in a resonance fatigue test according to an embodiment of the present invention.

FIG. 6 is a diagram illustrating the comparison of symmetrical bending and nonsymmetrical bending of blade.

FIG. 7A is a graph illustrating the distribution of edgewise test moment load extracted by a signal analysis method according to an embodiment of the present invention.

FIG. 7B is a graph illustrating the ratio of edgewise test moment load to edgewise target moment load according to an embodiment of the present invention.

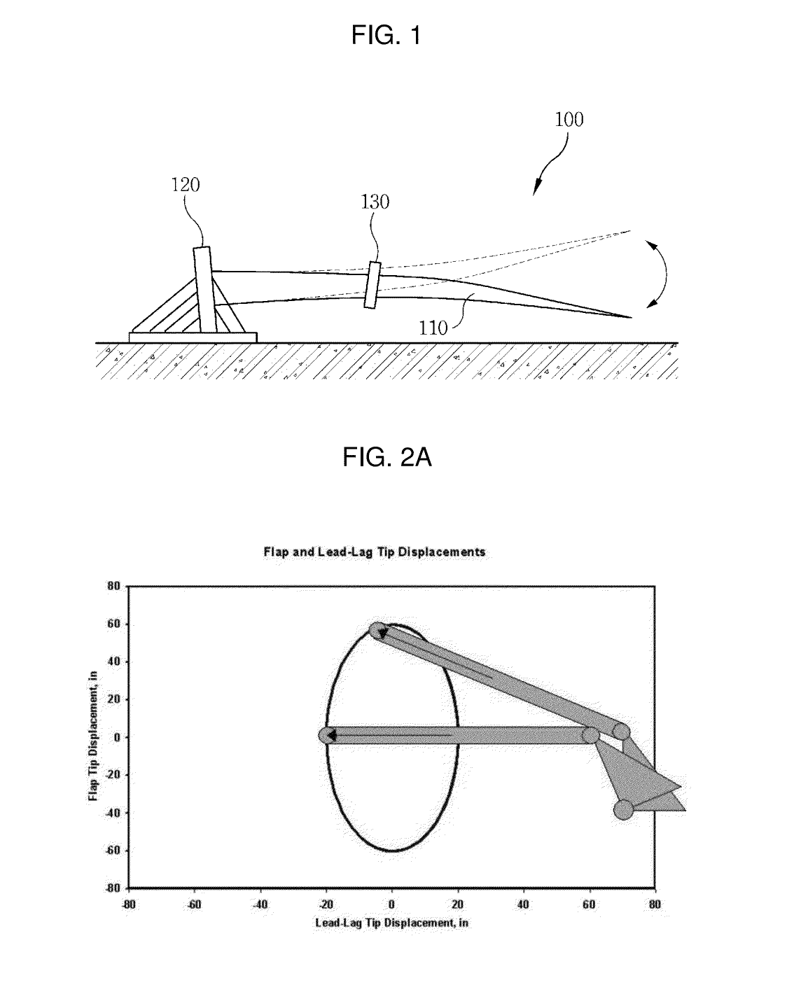

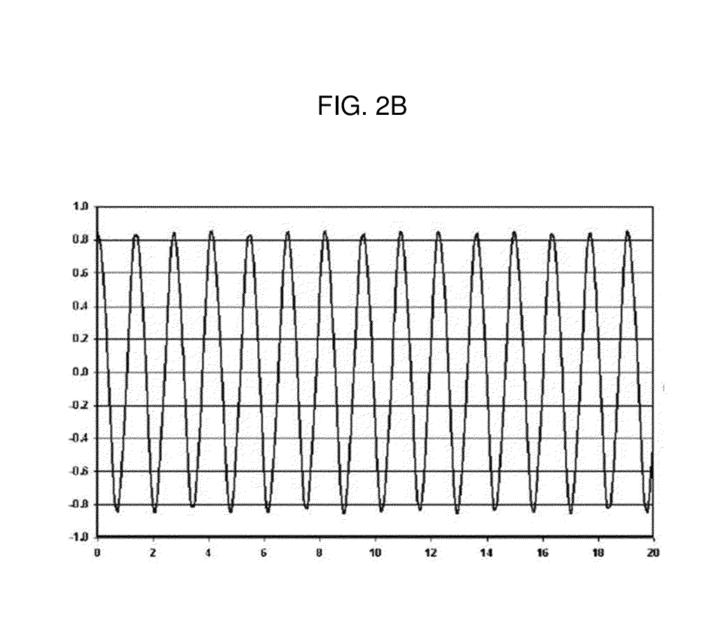

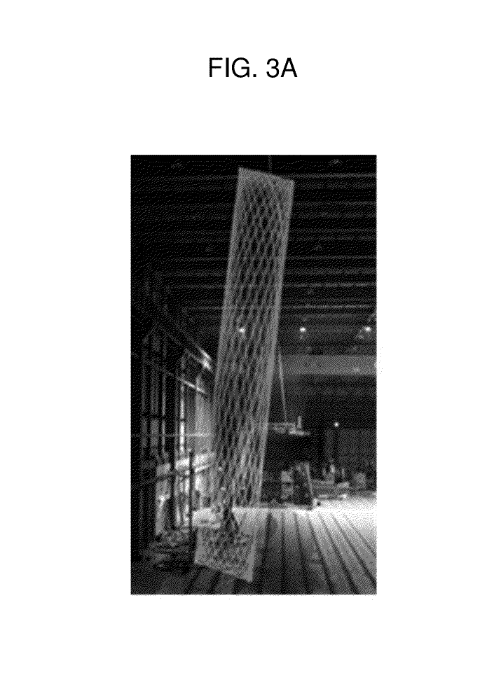

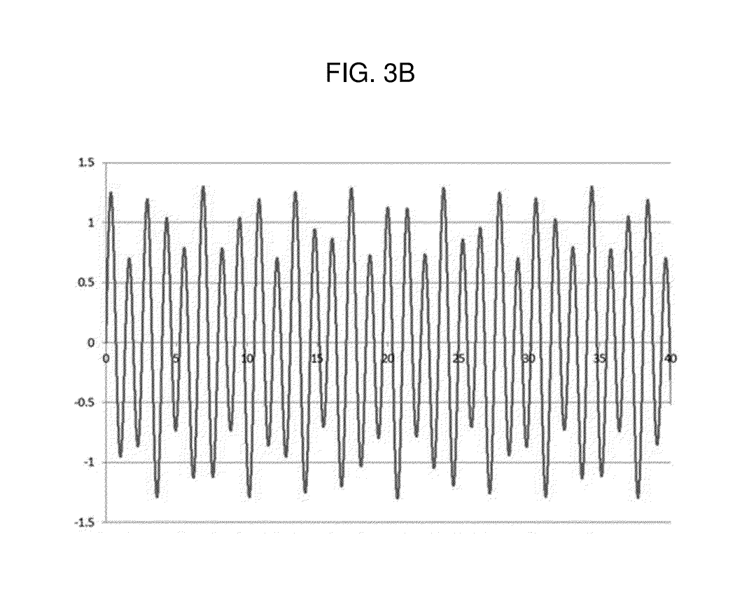

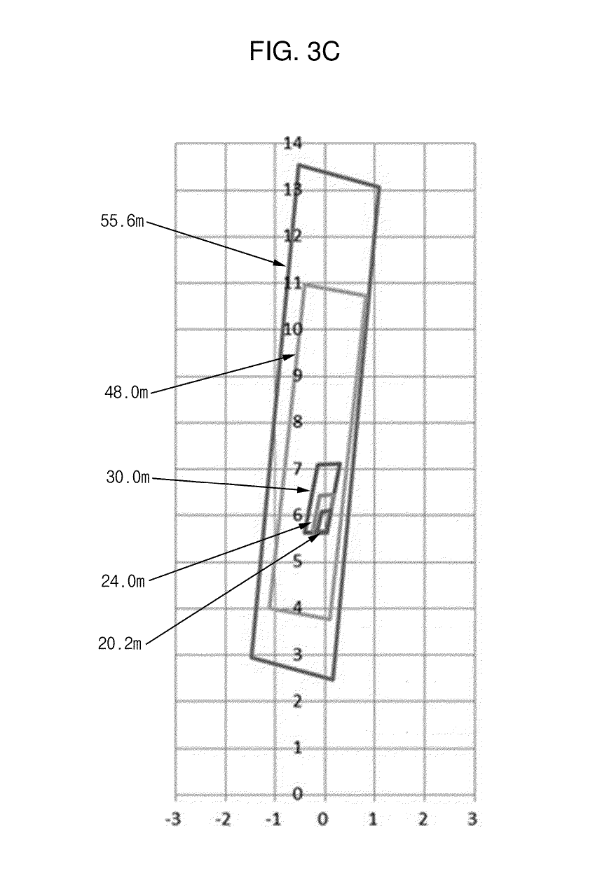

### DETAILED DESCRIPTION

Hereinafter, embodiments of the present invention will be described with reference to the accompanying drawings.

This invention may be embodied in many different forms and should not be construed as limited to the embodiments set forth herein. Rather, the disclosed embodiments are provided so that this invention will be thorough and complete, and will fully convey the scope of the invention to those skilled in the art. The principles and features of the present invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention. Through the drawings, the same or similar reference numerals denote corresponding features consistently.

Unless defined differently, all terms used herein, which include technical terminologies or scientific terminologies, have the same meaning as that understood by a person skilled in the art to which the present invention belongs. Singular forms are intended to include plural forms unless the context clearly indicates otherwise.

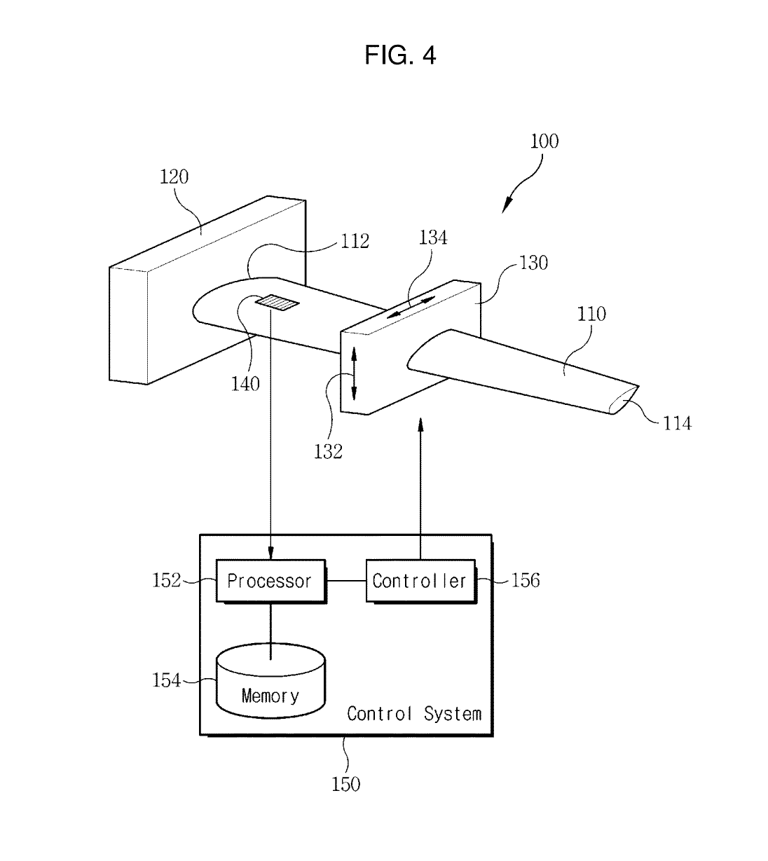

FIG. 4 is a schematic diagram illustrating a resonance fatigue test apparatus according to an embodiment of the present invention.

Referring to FIG. 4, the resonance fatigue test apparatus 100 is an apparatus configured to perform a fatigue test for a test article such as a wind turbine blade 110. Although the test article is a wind turbine blade in this embodiment, this is exemplary only and not to be considered as a limitation of the present invention. In other various embodiments, the test article may be a bridge, a building, a yacht mast, or any other structure which has a possibility of oscillation and needs a fatigue test.

The blade 110 is fixed to a test stand 120 at one end thereof, i.e., a root 112, thus forming a cantilever beam. The other end of the blade 110 is referred to as a tip 114.

An exciter 130 is mounted on the blade 110. The exciter 130 applies a repeated force to the blade 110 under the control of a controller 156 to be discussed below, thus inducing oscillation of the blade 110. The exciter 130 is illustrated simply in FIG. 4, and types or detailed structures thereof do not limit the invention. Namely, the exciter 130 may have various types such as external exciter type, on-board rotating exciter type, on-board linear exciter type, and the like, and each type exciter may have various structures. For example, in case of on-board linear exciter type, the exciter 130 has an actuator and a mass. The actuator enables the mass to move back and forth linearly, thereby creating an inertia force. A resonance fatigue test adjusts the oscillating frequency of such a linear motion of the mass to approach the natural frequency of the entire blade structure so that resonance occurs. In case of a dual-axis resonance fatigue test, the exciter 130 may be separately formed of a flapwise exciter and an edgewise exciter, or alternatively implemented in the form of an integrated structure in which a flapwise actuator and an edgewise actuator are equipped together.

A resonance fatigue test is controlled by a control system 150, which includes a processor 152, a memory 154, and a controller 156. The memory 154 stores test conditions and data required for or associated with a resonance fatigue test. For example, one of test conditions prescribes that a test bending moment distribution caused by oscillation of the blade 110 should exceed a target bending moment distribution. Data stored in the memory 154 may include a target cycle of fatigue test, a natural frequency of blade, a target moment load, a test moment load extracted by the processor 152, and the like. Each kind of data may have different values according to flapwise and edgewise directions.

The controller 156 is connected to the exciter 130 and applies an excitation force to the exciter 130. Namely, based on test conditions and data stored in the memory 154, the controller 156 adjusts the excitation force of the exciter 130 to oscillate the blade 110 with a desired amplitude in a target cycle. In case of a dual-axis test, the controller 156 may separately apply a flapwise control signal and an edgewise control signal to the exciter 130. At this time, a flapwise frequency and an edgewise frequency may be different from each other.

At least two strain gauges 140 are attached respectively to several spots of the blade 110. The strain gauge 140 creates a measured signal by measuring a physical quantity (e.g., strain) caused by oscillation of the blade 110 and then transmits the measured signal to the processor 152. The processor 152 processes the measured signal and stores the processed signal in the memory unit 154. Also, based on the processed signal, the controller 156 performs a control operation. The strain gauge 140 is an example of a measurement sensor and not to be considered as a limitation of this invention. Alternatively or additionally, any other sensor such as an optical sensor, an acceleration sensor, a displacement gauge, or the like may be selectively used. If there are a lot of strain gauges 140, a data acquisition device (not shown) may be used for collecting the measured signals from the strain gauges 140 and for transmitting the collected signals to the processor 152.

In FIG. 4, a single strain gauge 140 is shown to avoid complexity. However, practically, at least two strain gauges 140 should be disposed at different positions on the same cross-section of the blade 110 (i.e., at the same distance from the blade root). Additionally, such dispositions of the strain gauges 140 may be distributed at several cross-sections along the longitudinal direction of the blade 110.

Meanwhile, the strain gauge 140 may be used for moment calibration performed before a fatigue test. In the moment calibration, a static load is applied to the blade 110, and a resultant measured value (e.g., strain) is obtained from the strain gauges 140. After this process is performed separately in the flapwise direction and in the edgewise direction, a correlation (e.g., linear ratio) between the measured values and moment values obtained from the static loads is calculated. As will be described later, if a measured signal is received from the strain gauge 140 during a fatigue test, the processor 152 can extract a moment load by using this correlation which is predetermined by means of moment calibration. This moment calibration is fully disclosed in a copending patent application Ser. No. 14/885,644 titled “Method and Apparatus of Moment Calibration for Resonance Fatigue Test”, which is hereby incorporated by reference in its entirety into the present application.

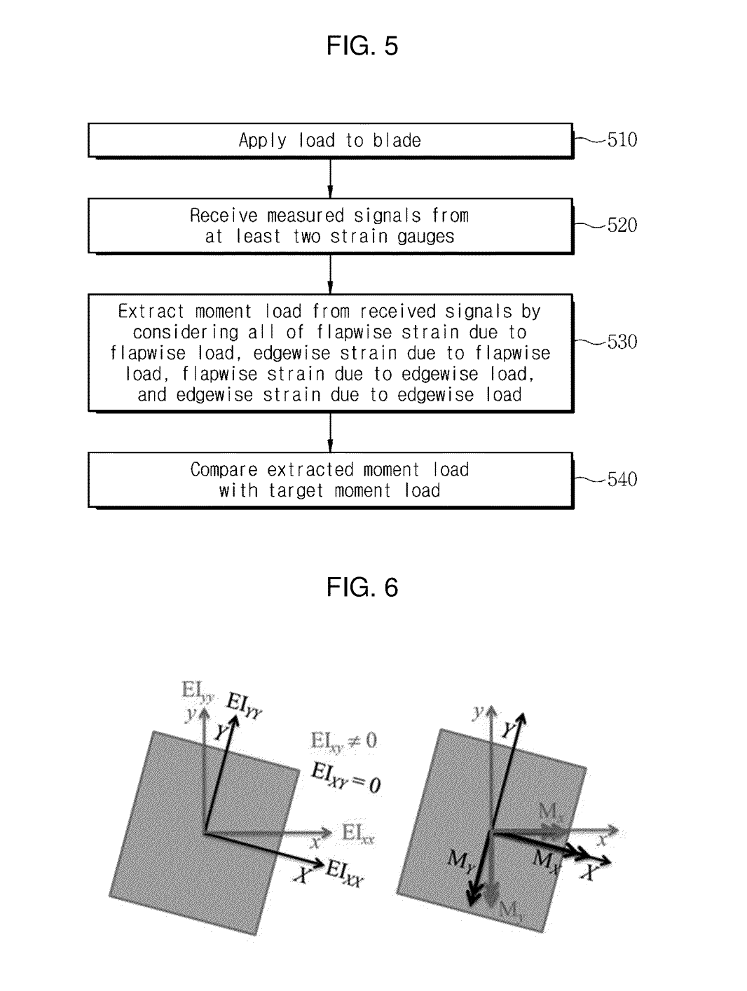

Now, a method for analyzing a measured signal in a resonance fatigue test according to an embodiment of the present invention will be described with reference to FIGS. 5 and 6. FIG. 5 is a flow diagram illustrating a method for analyzing a measured signal in a resonance fatigue test according to an embodiment of the present invention. FIG. 6 is a diagram illustrating the comparison of symmetrical bending and nonsymmetrical bending of blade. The measured signal analysis method may be performed at the processor 152 of the control system 150 as shown in FIG. 4.

Referring to FIG. 5, at step 510, the controller 156 of the control system 150 applies a driving force to the exciter 130, based on test conditions and data stored in the memory 154. By the excitation of the exciter 130, a load is applied to the blade 110 and thereby oscillation of the blade 110 occurs. At this time, a flapwise or edgewise driving force is applied to the exciter 130 in case of a single-axis test, and flapwise and edgewise driving forces are applied to the exciter 130 in case of a dual-axis test. In the latter case, flapwise and edgewise frequencies may be different from each other. By the way, regardless of either a single-axis test or a dual-axis test, nonsymmetrical bending of the blade 110 is caused due to stiffness coupling. Therefore, as mentioned above, the blade 110 moves in a diagonal direction which is not parallel with the direction of excitation force applied thereto. This diagonal motion of the blade 110 brings about an inertia force having horizontal and vertical components, resulting in dual-axis load components.

Referring to FIG. 6, M_{X} and M_{Y} denote an edgewise moment load and a flapwise moment load, respectively, in symmetrical bending, whereas Mₓ and M_{y} denote an edgewise moment load and a flapwise moment load, respectively, in nonsymmetrical bending. Also, EI_{XX} and EI_{YY} denote bending stiffness in a principal axis direction in symmetrical bending, whereas EIₓₓ and EI_{yy} denote edgewise bending stiffness and flapwise bending stiffness, respectively, in nonsymmetrical bending. Further, EI_{XY} and EI_{xy} denote bending stiffness associated with stiffness coupling.

As shown in FIG. 6, while bending stiffness (EI_{XY}) associated with stiffness coupling does not exist in symmetrical bending, bending stiffness (EI_{xy}) associated with stiffness coupling exists in nonsymmetrical bending.

Returning to FIG. 5, at step 520, the processor 152 receives a measured signal from each of at least two strain gauges 140. This measured signal is a response signal created according to the behavior of the blade 110. By the way, since the behavior of the blade 110 is very complicated due to interference (i.e., coupling) between flapwise and edgewise motions, a process of extracting a desired physical quantity form the measured signal is needed.

At step 530, the processor 152 extracts a moment load from the received, measured signal by considering all of a flapwise strain due to a flapwise load, an edgewise strain due to a flapwise load, a flapwise strain due to an edgewise load, and an edgewise strain due to an edgewise load.

Specifically, when a distance between the neutral plane of the blade and the strain gauge with regard to flapwise bending is denoted by xᵢ, a distance between the neutral plane and the strain gauge with regard to edgewise bending is denoted by yᵢ, a curvature with regard to flapwise bending is denoted by ρ_{y}, and a curvature with regard to edgewise bending is denoted by ρₓ, a strain ε_{zz} is expressed as Equation 1 given below.

$${ɛ}_{zz} = \frac{{y}_{i}}{{ρ}_{x}} + \frac{{x}_{i}}{{ρ}_{y}} \qquad [ Equation 1 ]$$

Additionally, such curvatures (ρₓ, ρ_{y}) are expressed as Equation 2 given below.

$$\{ \begin{matrix}\frac{1}{{ρ}_{x}} \\ \frac{1}{{ρ}_{y}}\end{matrix} \} = [ \begin{matrix}\frac{{EI}_{yy}}{{EI}_{xx} {EI}_{yy} - {( {EI}_{xy} )}^{2}} & \frac{- {EI}_{xy}}{{EI}_{xx} {EI}_{yy} - {( {EI}_{xy} )}^{2}} \\ \frac{- {EI}_{xy}}{{EI}_{xx} {EI}_{yy} - {( {EI}_{xy} )}^{2}} & \frac{{EI}_{xx}}{{EI}_{xx} {EI}_{yy} - {( {EI}_{xy} )}^{2}}\end{matrix} ] \{ \begin{matrix}{M}_{x} \\ {M}_{y}\end{matrix} \} \qquad [ Equation 2 ]$$

In Equation 2, a 2×2 matrix regarding bending stiffness (EI) represents stiffness coupling, and a 2×1 matrix regarding moment load (M) represents dual-axis moment components. Stiffness coupling is caused by material characteristics and shape characteristics of the blade. Dual-axis moment components are caused by an inertia force during a resonance motion of the blade. In case of a dual-axis fatigue test, flapwise and edgewise motions of the blade invoke interference therebetween, so that moment is also subjected to coupling. Namely, moment coupling may be regarded as occurring by inertia coupling (or referred to as mass coupling) due to a blade behavior.

Equation 2 expresses a complicated behavior of the blade resulting from interference (i.e., a coupling effect) between flapwise and edgewise directions. Also, Equation 2 indicates that all of a flapwise strain due to a flapwise load, an edgewise strain due to a flapwise load, a flapwise strain due to an edgewise load, and an edgewise strain due to an edgewise load should be considered in order to obtain a moment load of the blade.

From Equations 1 and 2, strain under a dual-axis load state is expressed as Equation 3.

$${ɛ}_{zz}^{( i )} = \frac{{y}_{i}}{{ρ}_{x}} + \frac{{x}_{i}}{{ρ}_{y}} = \frac{{EI}_{xx} {x}_{i} - {EI}_{xy} {y}_{i}}{{EI}_{xx} {EI}_{yy} - {( {EI}_{xy} )}^{2}} {M}_{y} + \frac{{EI}_{yy} {y}_{i} - {EI}_{xy} {x}_{i}}{{EI}_{xx} {EI}_{yy} - {( {EI}_{xy} )}^{2}} {M}_{x} = {e}_{f}^{( i )} {M}_{y} + {e}_{e}^{( i )} {M}_{x} \qquad [ Equation 3 ]$$

In Equation 3, superscript (i) means the i-th strain gauge. Additionally, e_{f}⁽ⁱ⁾ denotes a linear ratio between a flapwise moment and a measured strain value, and eₑ⁽ⁱ⁾ denotes a linear ratio between an edgewise moment and a measured strain value. As mentioned above, these linear ratios are already known values which have been obtained during moment calibration before a resonance fatigue test.

Therefore, if the processor 152 receives a measured signal (i.e., strain ε_{zz}⁽ⁱ⁾) from the i-th strain gauge and also receives a measured signal (i.e., strain ε_{zz}^{(j)}) from the j-th strain gauge at step 520, the processor 152 can extract, at step 530, moment load values (Mₓ and M_{y}) in Equation 3 by using already known correlation values (i.e., linear ratios e_{f}⁽ⁱ⁾, eₑ⁽ⁱ⁾, e_{f}^{(j)}, eₑ^{(j)}).

Thereafter, at step 540, the processor 152 compares the extracted moment load with a target moment load. In case of a single-axis resonance fatigue test, the extracted moment load is compared immediately with the target moment load stored in the memory. However, in case of a dual-axis resonance fatigue test, the extracted moment load is compared with the target moment load after being converted into single-axis equivalent moment loads in flapwise and edgewise directions. This conversion of moment load into single-axis equivalent moment loads is fully disclosed in a copending patent application Ser. No. 14/885,731 titled “Method and Apparatus of Multi-axis Resonance Fatigue Test”, which is hereby incorporated by reference in its entirety into the present application.

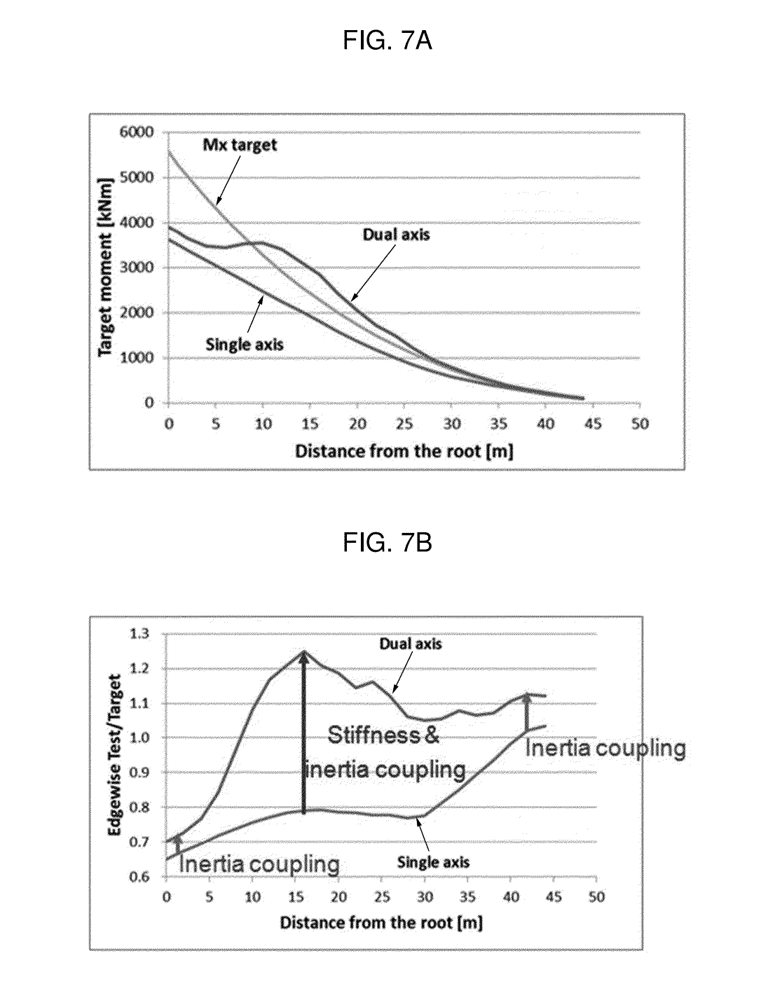

FIG. 7A is a graph illustrating the distribution of edgewise test moment load extracted by a signal analysis method according to an embodiment of the present invention. Also, FIG. 7B is a graph illustrating the ratio of edgewise test moment load to edgewise target moment load according to an embodiment of the present invention.

Referring to FIG. 7A, a moment load distribution is obtained according to a distance from the blade root. According to test conditions, a test moment load should exceed a target moment load. Therefore, based on comparison results at step 540, the processor 152 may adjust a driving force applied to the exciter 130 through the controller 156.

Meanwhile, as shown in FIGS. 7A and 7B, a moment load is further increased in a dual-axis resonance fatigue test in comparison with a single-axis resonance fatigue test. This is caused by a coupling effect as shown in FIG. 7B. Particularly, a section in which a test moment load exceeds a target moment load is affected considerably by stiffness coupling.

The above-discussed method for analyzing a measured signal according to the present invention can be efficiently applied to a test setup procedure for a resonance fatigue test as well as to the full-scale resonance fatigue test.

While the present invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for analyzing a measured signal in a resonance fatigue test of a test article, the method comprising steps of:
receiving the measured signal from each of at least two measurement sensors attached to the test article; and
extracting a moment load from the received measured signal by considering all of a first measured value in a first direction due to a first direction load, a second measured value in a second direction due to the first direction load, a third measured value in the first direction due to a second direction load, and a fourth measured value in the second direction due to the second direction load.

2. A method for analyzing a measured signal in a resonance fatigue test of a test article, the method comprising steps of:
receiving the measured signal from each of at least two strain gauges attached to the test article; and
extracting a moment load from the received measured signal by considering all of a first flapwise strain due to a flapwise load, a first edgewise strain due to the flapwise load, a second flapwise strain due to an edgewise load, and a second edgewise strain due to the edgewise load.

3. The method of claim 2, wherein the at least two strain gauges are disposed at different positions on the same cross-section of the test article.

4. The method of claim 2, further comprising step of:
comparing the extracted moment load with a target moment load in case of a single-axis resonance fatigue test.

5. The method of claim 2, further comprising step of:
comparing the extracted moment load with a target moment load after converting the extracted moment load into single-axis equivalent moment loads in case of a dual-axis resonance fatigue test.

6. The method of claim 5, wherein the dual-axis resonance fatigue test is performed with different frequencies in flapwise and edgewise directions.

7. The method of claim 2, wherein the test article is one of a wind turbine blade, a bridge, a building, a yacht mast, or any other structure which has a possibility of oscillation and needs a fatigue test.

8. A resonance fatigue test apparatus for a test article, the apparatus comprising:
a test stand configured to fix one end of the test article;
an exciter mounted on the test article and configured to apply a repeated force to the test article so as to induce oscillation;
a controller connected to the exciter and configured to apply a driving force to the exciter;
at least two measurement sensors attached to the test article and configured to measure a physical quantity caused by the oscillation of the test article and thereby to create a measured signal; and
a processor configured to receive the measured signal from each of the at least two measurement sensors, and to extract a moment load from the received measured signal by considering all of a first measured value in a first direction due to a first direction load, a second measured value in a second direction due to the first direction load, a third measured value in the first direction due to a second direction load, and a fourth measured value in the second direction due to the second direction load.

9. The apparatus of claim 8, wherein the measurement sensor is a strain gauge, wherein the first direction and the second direction are a flapwise direction and an edgewise direction, respectively, and wherein the measured value is strain.

10. The apparatus of claim 8, wherein the at least two measurement sensors are disposed at different positions on the same cross-section of the test article.

11. The apparatus of claim 8, further comprising:
a memory configured to store test conditions and data required for or associated with a resonance fatigue test, including a target moment load and the moment load extracted by the processor.

12. The apparatus of claim 11, wherein the processor is further configured to compare the extracted moment load with the stored target moment load in case of a single-axis resonance fatigue test.

13. The apparatus of claim 11, wherein the processor is further configured to compare the extracted moment load with the stored target moment load after converting the extracted moment load into single-axis equivalent moment loads in case of a dual-axis resonance fatigue test.

14. The apparatus of claim 13, wherein the dual-axis resonance fatigue test is performed with different frequencies in flapwise and edgewise directions.

15. The apparatus of claim 8, wherein the test article is one of a wind turbine blade, a bridge, a building, a yacht mast, or any other structure which has a possibility of oscillation and needs a fatigue test.
